(19) United States
(12) Patent Application Publication
(10) Pub. No.: US 2020/0167307 A1
(43) Pub. Date: May 28, 2020

(54) IN-VEHICLE RELAY DEVICE, CONTROL PROGRAM, AND MEMORY SHARING METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Ryo Okada, Yokkaichi, Mie (JP)

(21) Appl. No.: 16/612,073

(22) PCT Filed: Apr. 20, 2018
(86) PCT No.: PCT/JP2018/016226

§ 371 Date: Nov. 8, 2019

(30) Foreign Application Priority Data
May 9, 2017 (JP) 2017-092963

(51) Int. Cl. G06F 13/40; G06F 13/16; G06F 3/06; B60R 16/00

(52) U.S. Cl. CPC G06F 13/4027; G06F 13/1668; B60R 16/005; G06F 3/0659; G06F 3/0679; G06F 3/0604

(57) ABSTRACT

An in-vehicle relay device to which a plurality of communication lines installed in a vehicle are connectable performs processing for relaying communication between the communication lines, the device includes: a processor that includes an acquisition unit that acquires an update program for updating a program executed by an in-vehicle device connected to one of the communication lines and an update processing unit that performs processing for updating a program by transmitting an update program acquired by the acquisition unit to the in-vehicle device; a communication IC that performs, by executing a communication program, processing relating to communication performed via the communication lines; and a shared memory that is accessible by the processor and the communication IC, wherein an update program acquired by the acquisition unit of the processor and the communication program executed by the communication IC are stored in the shared memory.

### CROSS-REFERENCE TO RELATED APPLICATIONS

This application is the U.S. national stage of PCT/JP2018/016226 filed on Apr. 20, 2018, which claims priority of Japanese Patent Application No. JP 2017-092963 filed on May 9, 2017, the contents of which are incorporated herein.

### TECHNICAL FIELD

The present disclosure relates to an in-vehicle relay device to which a plurality of communication lines installed in a vehicle are connected and that relays communication between the plurality of communication lines, a control program, and a memory sharing method.

### BACKGROUND

A vehicle is conventionally equipped with a large number of in-vehicle devices, such as Electronic Control Units (ECUs). The in-vehicle devices are connected to each other via communication lines that are arranged in the vehicle, and cooperate with each other by exchanging information through communication with each other. As a protocol for communication that is performed by in-vehicle devices, Controller Area Network (CAN) or Ethernet (registered trademark) is adopted, for example. The CAN communication protocol adopts a network configuration in which a plurality of in-vehicle devices are connected to a common communication line (a CAN bus), but the number of devices that can be connected to a single communication line has an upper limit, and therefore, in many cases, a plurality of communication lines are provided in a vehicle and an in-vehicle relay device that is called a gateway relays communication between the communication lines. The Ethernet communication protocol adopts a star-shaped network configuration in which a plurality of in-vehicle devices are connected to a single in-vehicle relay device via respective communication lines, and the in-vehicle relay device relays communication between the in-vehicle devices.

Recent years have seen studies and development of what is called remote reprogramming, which is a technology for remotely updating, through wireless communication, programs that are executed by processors of in-vehicle devices. In this technology, a vehicle communicates with a server device through wireless communication via a mobile phone communication network or a wireless Local Area Network (LAN), acquires an update program by downloading it from the server device, and updates a program of an in-vehicle device to be updated by using the acquired update program. As a device that performs processing such as acquiring an update program from the server device and transmitting the update program to an in-vehicle device, an in-vehicle relay device to which a plurality of communication lines are connected is suitable.

As a technology for updating a program of an in-vehicle device, for example, JP 2016-127449A proposes an in-vehicle relay device that determines whether a program can be updated, based on a required charge amount of a capacitor, which is required for updating the program, and a remaining charge amount of the capacitor, and if it is determined that the program can be updated, causes an update-target in-vehicle device to start to update the program.

In a configuration in which an in-vehicle relay device performs processing that relates to update of a program of an in-vehicle device, the in-vehicle relay device needs to include a storage device for temporarily storing an update program acquired from a server device. As such a storage device, a non-volatile memory element that has a relatively large capacity and allows for overwriting of data, such as a flash memory, can be adopted.

On the other hand, in-vehicle relay devices are equipped with a large number of Integrated Circuits (ICs), such as a processor, a memory, and the like, that are installed on a circuit board. Recent years have seen an increase in the number of installed ICs and high-functionalization of installed ICs along with high-functionalization of in-vehicle relay devices. Under the above circumstances, an IC that performs processing by reading a program that is stored in a memory is sometimes installed, other than the main processor of an in-vehicle relay device. Such an IC requires a non-volatile memory element, such as a Read Only Memory (ROM) or a flash memory, for storing the program and accordingly, there is a risk that the number of memory elements installed on a circuit board of an in-vehicle relay device will be increased.

The present disclosure was made in view of the above circumstances, and an object of the present disclosure is to provide an in-vehicle relay device, a control program, and a memory sharing method that can suppress an increase in the number of installed memory elements.

### SUMMARY

An in-vehicle relay device according to the present disclosure is an in-vehicle relay device to which a plurality of communication lines installed in a vehicle are connectable and that performs processing for relaying communication between the plurality of communication lines, the in-vehicle relay device including: a processor that includes an acquisition unit configured to acquire an update program for updating a program that is executed by an in-vehicle device connected to one of the communication lines and an update processing unit configured to perform processing for updating a program by transmitting an update program acquired by the acquisition unit to the in-vehicle device; a communication Integrated Circuit (IC) configured to perform, by executing a communication program, processing relating to communication that is performed via the plurality of communication lines; and a shared memory that is accessible by the processor and the communication IC, wherein an update program acquired by the acquisition unit of the processor and the communication program executed by the communication IC are stored in the shared memory.

The in-vehicle relay device according to the present disclosure further includes a route selection unit configured to selectively enable access via an access route from the processor to the shared memory or an access route from the communication IC to the shared memory, wherein the processor controls selection of a route by the route selection unit.

In the in-vehicle relay device according to the present disclosure, if an ignition switch or an accessory switch of the vehicle is switched from OFF to ON, the processor controls selection of a route by the route selection unit to enable access via the access route from the communication IC to the shared memory, and after the communication program stored in the shared memory is read by the communication IC, the processor controls selection of a route by the route selection unit to enable access via the access route from the processor to the shared memory.

In the in-vehicle relay device according to the present disclosure, the shared memory includes a plurality of storage regions for storing the communication program, region information that indicates from which of the storage regions the communication IC is to read the communication program is stored in the shared memory, and the communication IC reads the communication program from a storage region of the shared memory that is indicated by the region information.

In the in-vehicle relay device according to the present disclosure, the processor acquires an update program for the communication IC through the acquisition unit, stores the update program in one of the storage regions of the shared memory, and updates the region information.

A control program according to the present disclosure causes a processor included in an in-vehicle relay device that performs processing for relaying communication between a plurality of communication lines installed in a vehicle to: acquire an update program for updating a program that is executed by an in-vehicle device connected to one of the communication lines; perform processing for storing the acquired update program in a shared memory that is accessible by a communication IC that performs, by executing a communication program, processing relating to communication that is performed via the plurality of communication lines; perform processing for updating a program by transmitting the update program stored in the shared memory to the in-vehicle device; and control selection of a route by a route selection unit that selectively enables access via an access route from the processor to the shared memory or an access route from the communication IC to the shared memory.

If an ignition switch or an accessory switch of the vehicle is switched from OFF to ON, the control program according to the present disclosure causes the processor to control selection of a route by the route selection unit to enable access via the access route from the communication IC to the shared memory, and after the communication program that is stored in the shared memory is read by the communication IC, the control program causes the processor to control selection of a route by the route selection unit to enable access via the access route from the processor to the shared memory.

A memory sharing method according to the present disclosure is a memory sharing method for sharing a memory between a processor and a communication IC that are included in an in-vehicle relay device that performs processing for relaying communication between a plurality of communication lines that are installed in a vehicle, the method including: acquiring, by the processor, an update program for updating a program that is executed by an in-vehicle device connected to one of the communication lines, storing, by the processor, the acquired update program in a shared memory, and performing, by the processor, processing for updating a program by transmitting the stored update program to the in-vehicle device; and performing, by the communication IC, processing relating to communication that is performed via the plurality of communication lines, by executing a communication program that is stored in the shared memory.

In the present disclosure, an in-vehicle relay device acquires an update program for an in-vehicle device and transmits the acquired update program to the in-vehicle device to be updated, and thus a program of the in-vehicle device is updated. The in-vehicle relay device includes a processor that performs various kinds of processing including processing for updating in-vehicle devices and a communication IC that performs processing relating to communication. The communication IC performs processing relating to communication by executing a communication program.

In this configuration, the in-vehicle relay device according to the present disclosure includes a shared memory that is accessible by both the processor and the communication IC. An update program that is acquired by the processor and the communication program executed by the communication IC are stored in the shared memory. This eliminates the need for providing, as separate elements, a memory element in which the processor stores the update program and a memory element for storing the communication program of the communication IC, and therefore the number of memory elements included in the in-vehicle relay device can be reduced.

Further, in the present disclosure, the in-vehicle relay device includes a route selection unit that selectively enables access via an access route from the processor to the shared memory or an access route from the communication IC to the shared memory, and the processor controls selection by the route selection unit.

For example, if an ignition switch or an accessory switch of the vehicle is switched from OFF to ON, the processor controls the selection by the route selection unit to enable access via the access route from the communication IC to the shared memory. As a result, when the ignition switch or the accessory switch is switched from OFF to ON and the in-vehicle relay device starts operation, the communication IC can read the communication program from the shared memory and start processing relating to communication. Further, after the communication program is read by the communication IC from the shared memory, the processor controls the selection by the route selection unit to enable access via the access route from the processor to the shared memory. As a result, when the processor acquires an update program, the processor can store the update program in the shared memory.

It is sufficient that the communication IC reads the communication program once, after the device is activated. Therefore, a configuration is possible in which the communication IC accesses the shared memory right after the device is activated and thereafter the processor accesses the shared memory, and thus the memory can be shared without access from the processor to the shared memory and access from the communication IC to the shared memory colliding with each other.

Further, the communication program executed by the communication IC can be updated in the present disclosure. For this purpose, the shared memory includes a plurality of storage regions in which the communication program can be stored, and region information that indicates from which of the storage regions the communication IC is to read the communication program is stored in the shared memory. The communication IC reads the communication program from the storage region that is indicated by the region information. Therefore, an update program for the communication IC can be stored in a storage region that is not indicated by the region information, without operation of the communication IC being affected. After the processor has stored the acquired update program for the communication IC in the storage region of the shared memory that is not indicated by the region information, the processor updates the region information so that the communication IC will read the communication program from this storage region. As a result, the next time the communication IC reads the communication program, the communication IC reads, as the communication program, the update program acquired by the processor and stored in the shared memory, and thus the communication program can be updated.

### Advantageous Effects of Disclosure

According to the present disclosure, a memory serves as both a memory for storing an update program that is acquired by the processor and a memory for storing the communication program to be read by the communication IC, and therefore the number of memory elements that are included in the in-vehicle relay device can be reduced.

### BRIEF DESCRIPTION OF DRAWINGS

FIG. 1 is a schematic diagram showing a configuration of a communication system according to the present embodiment.

FIG. 2 is a block diagram showing a configuration of a gateway according to the present embodiment.

FIG. 3 is a schematic diagram showing one example of content stored in a flash memory.

FIG. 4 is a circuit diagram showing a configuration of a bus switch.

FIG. 5 is a flowchart showing a procedure of processing performed by a processor of a gateway to control switching of a bus switch.

FIG. 6 is a flowchart showing a procedure of ECU update processing performed by the processor of the gateway.

FIG. 7 is a flowchart showing a procedure of ESW update processing performed by the processor of the gateway.

### DETAILED DESCRIPTION OF PREFERRED EMBODIMENTS

System Configuration

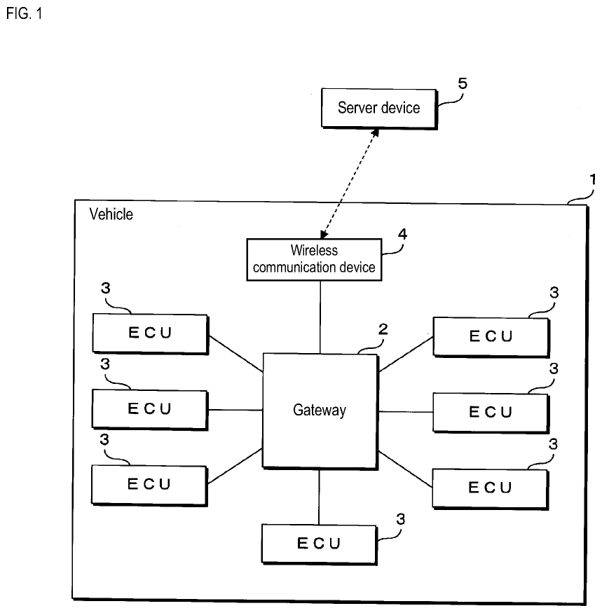

FIG. 1 is a schematic diagram showing a configuration of a communication system according to the present embodiment. The communication system according to the present embodiment has what is called a star-shaped network configuration in which a plurality of ECUs 3 that are installed in a vehicle 1 are connected to a gateway 2 via respective communication lines. In the present embodiment, the gateway 2 and the ECUs 3 perform communication in accordance with the Ethernet communication protocol. However, the communication protocol is not limited to Ethernet, and various communication protocols such as CAN or FlexRay can be adopted.

Upon receiving a message from one ECU 3, for example, the gateway 2 performs processing for relaying the message between a plurality of ECUs 3 by transmitting the message to one or more other ECUs 3. The ECUs 3 may include various ECUs such as an ECU that controls operation of an engine of the vehicle 1, a body ECU that controls operation of body-related equipment of the vehicle 1, an ECU that controls operation of an air-bag, and an ECU that controls an Antilock Brake System (ABS), for example.

A wireless communication device 4 is also connected to the gateway 2 via a communication line. The wireless communication device 4 is capable of communicating with various devices outside the vehicle 1 by using a wireless network, such as a mobile phone communication network or a wireless LAN. Therefore, the gateway 2 and the ECUs 3 installed in the vehicle 1 are capable of communicating with devices outside the vehicle 1 via the wireless communication device 4. In the present embodiment, the gateway 2 communicates with a server device 5 that is installed outside the vehicle 1, via the wireless communication device 4.

The gateway 2 according to the present embodiment performs processing for updating programs that are executed by the ECUs 3, in addition to processing for relaying messages between the ECUs 3. If an ignition switch of the vehicle 1 is switched from OFF to ON, for example, the gateway 2 communicates with the server device 5 via the wireless communication device 4 to inquire whether programs need to be updated regarding the ECUs 3 installed in the vehicle 1. The server device 5 is operated by the manufacturing company or a supplier of the vehicle 1, for example, manages versions of programs of the ECUs 3 installed in the vehicle 1, and performs processing for distributing update programs to the vehicle 1.

If the gateway 2 is informed by the server device 5 that a program needs to be updated, the gateway 2 acquires an update program by downloading it from the server device 5 and stores the acquired update program in its own memory. Then, after the ignition switch of the vehicle 1 is switched OFF, the gateway 2 transmits the stored update program to an ECU 3 to be updated. The ECU 3 that received the update program from the gateway 2 updates a program that is stored in its own memory, by replacing the program with the received update program.

### Device Configuration

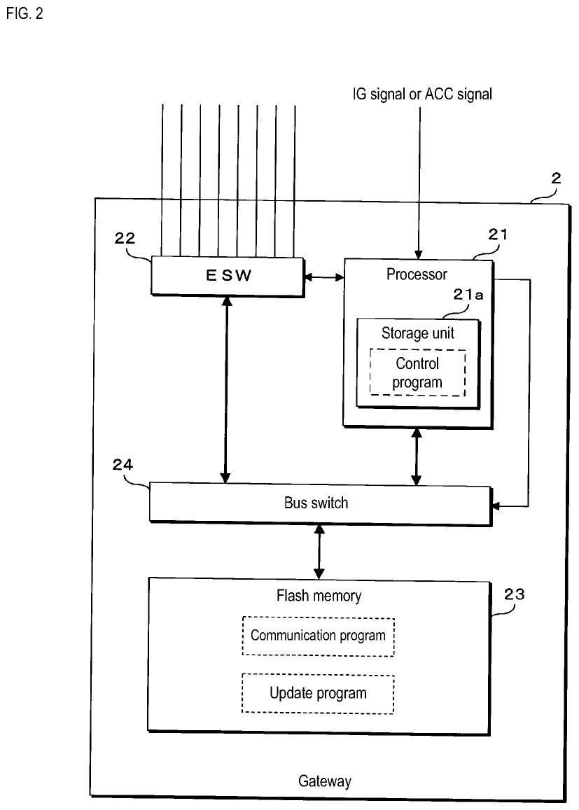

FIG. 2 is a block diagram showing a configuration of the gateway 2 according to the present embodiment. The gateway 2 according to the present embodiment includes a processor 21, an Ethernet switch (ESW) 22, a flash memory 23, a bus switch 24, and the like. The processor 21 is an IC that includes an arithmetic processing device, such as a Central Processing Unit (CPU) or a Micro-Processing Unit (MPU), and performs various kinds of processing, such as communication relaying processing and processing for updating programs of the ECUs 3, by reading and executing predetermined control programs. In the present embodiment, the processor 21 includes a storage unit 21a in which control programs to be executed by the processor 21 are stored, but a configuration is also possible in which the gateway 2 includes a ROM or the like in which the control programs to be executed by the processor 21 are stored, or the control programs are stored in the flash memory 23, for example. The control programs to be executed by the processor 21 may be directly written into the storage unit 21a of the processor 21 before the processor 21 is installed on a circuit board in a manufacturing process of the gateway 2, or may be written into the storage unit 21a using a communication function of the gateway 2, for example. Alternatively, a configuration is also possible in which the control programs are provided in a state of being recorded on a recording medium, such as a memory card or an optical disk, are read from the recording medium using a device, such as a memory card slot or an optical disk drive, that is provided in the gateway 2 or the vehicle 1, and are written into the storage unit 21a of the processor 21, for example.

In the present embodiment, an IG signal that indicates the state of the ignition switch of the vehicle 1 or an ACC signal that indicates the state of an accessory switch is input to the processor 21, and the processor 21 is capable of performing processing in accordance with the IG signal or the ACC signal. Also, the processor 21 is capable of controlling operation of the ESW 22 and operation of the bus switch 24, and is also capable of reading data from and writing data into the flash memory 23. The processor 21 acquires an update program to be used for ECU 3 update processing from the server device 5 and stores the update program in the flash memory 23.

The ESW 22 transmits and receives messages (frames) to and from the ECUs 3 and the wireless communication device 4 that are connected to a plurality of communication lines, via the communication lines that are connected to the gateway 2. If the ESW 22 receives a message from an ECU 3 or the wireless communication device 4 via any of the communication lines, the ESW 22 determines a relay destination based on a MAC address or the like that is included in the message, and relays the message by transmitting the message via the communication line that is connected to the ECU 3 or wireless communication device 4 that is the relay destination. The ESW 22 includes an arithmetic processing device, such as a CPU or an MPU, and communication relaying processing such as that described above is performed as a result of the arithmetic processing device reading and executing a communication program that is stored in the flash memory 23.

The flash memory 23 is a non-volatile memory element into which data can be electrically written and from which data can be electrically erased. In the gateway 2 according to the present embodiment, the flash memory 23 is shared by the processor 21 and the ESW 22. An update program is stored in the flash memory 23 by the processor 21 and the communication program executed by the ESW 22 is also stored in the flash memory 23.

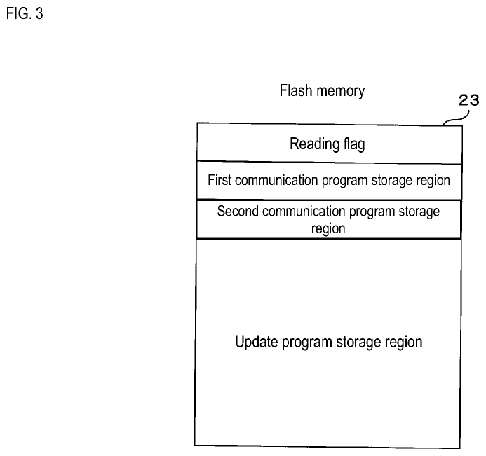

FIG. 3 is a schematic diagram showing one example of content stored in the flash memory 23. In the present embodiment, the flash memory 23 includes a region for storing a reading flag, a first communication program storage region, a second communication program storage region, and an update program storage region. Both the first communication program storage region and the second communication program storage region of the flash memory 23 are regions for storing a communication program to be read and executed by the ESW 22. The reading flag stored in the flash memory 23 is a flag that indicates from which of the first communication program storage region and the second communication program storage region the ESW 22 is to read the communication program. For example, if the value of the reading flag is “0”, the ESW 22 reads the communication program from the first communication program storage region and executes the communication program, and if the value of the reading flag is “1”, the ESW 22 reads the communication program from the second communication program storage region and executes the communication program.

That is, one of the first communication program storage region and the second communication program storage region of the flash memory 23 is the storage region in which the communication program to be executed by the ESW 22 at the current point in time is stored, and the other is a spare storage region. The spare storage region is used when the communication program of the ESW 22 is to be updated. If the communication program of the ESW 22 needs to be updated, the processor 21 of the gateway 2 acquires an update program from the server device 5 through wireless communication performed by the wireless communication device 4. The processor 21 writes the acquired update program into the storage region of the flash memory 23 that is not designated by the reading flag. After the update program is written, the processor 21 changes the value of the reading flag to designate the storage region in which the update program is stored, as the storage region from which the communication program is to be read. As a result, the next time the ESW 22 is activated, the ESW 22 can read and execute the updated communication program.

The update program storage region of the flash memory 23 is a region for storing an update program that is used for updating a program executed by an ECU 3 of the vehicle 1. If a program of an ECU 3 needs to be updated, the processor 21 of the gateway 2 acquires an update program for the ECU 3 from the server device 5 through wireless communication performed by the wireless communication device 4. The processor 21 stores the acquired update program in the update program storage region of the flash memory 23. Thereafter, at an appropriate timing such as when the ignition switch of the vehicle 1 is switched OFF, for example, the processor 21 reads the update program from the update program storage region of the flash memory 23 and transmits the update program to the ECU 3 to be updated. The ECU 3 that received the update program from the gateway 2 updates a program that is stored in its own memory, by replacing the program with the received update program.

As described above, the flash memory 23 of the gateway 2 is a shared memory that is shared by the processor 21 and the ESW 22. However, the processor 21 and the ESW 22 cannot simultaneously access the flash memory 23. Therefore, the bus switch 24 is provided between the flash memory 23 and each of the processor 21 and the ESW 22, and selection by the bus switch 24 is switched to enable only one of the processor 21 and the ESW 22 to access the flash memory 23 and prohibit the other from accessing the flash memory 23. The selection of the processor 21 or the ESW 22 by the bus switch 24 is switched based on control signals that are given from the processor 21.

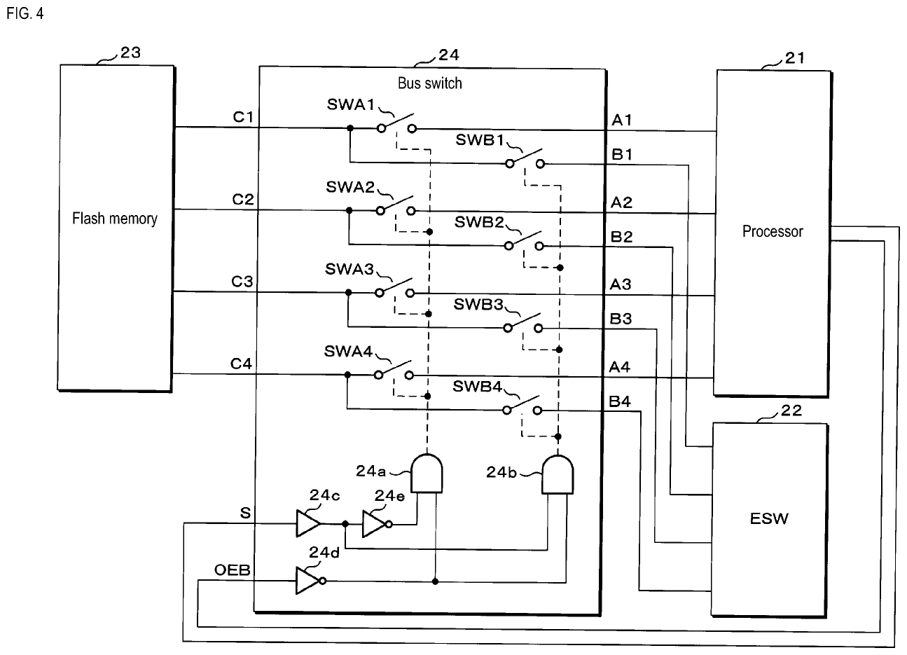

FIG. 4 is a circuit diagram showing a configuration of the bus switch 24. In the illustrated example, four signal lines C1 to C4 are connected to the flash memory 23, and reading of data from the flash memory 23, writing of data into the flash memory 23, erasing of data from the flash memory 23, and the like can be controlled via the signal lines C1 to C4. Accordingly, four signal lines A1 to A4 are connected to the processor 21 and four signal lines B1 to B4 are connected to the ESW 22, as signal lines for transmitting signals to and receiving signals from the flash memory 23. The signal lines A1 to A4, B1 to B4, and C1 to C4 are connected to the bus switch 24.

The bus switch 24 selectively connects the signal lines A1 to A4 connected to the processor 21 or the signal lines B1 to B4 connected to the ESW 22, to the signal lines C1 to C4. Operation of the bus switch 24 is controlled using two control signals, that is, a selection signal S and an enable signal OEB that are output from the processor 21. If the value of the selection signal S is “0” (low level), the bus switch 24 connects the signal lines A1 to A4 to the signal lines C1 to C4, and if the value of the selection signal S is “1” (high level), the bus switch 24 connects the signal lines B1 to B4 to the signal lines C1 to C4. Further, if the value of the enable signal OEB is “0”, the bus switch 24 connects the signal lines according to the selection signal S as described above. If the value of the enable signal OEB is “1”, the bus switch 24 does not connect the signal lines A1 to A4 and the signal lines B1 to B4 to the signal lines C1 to C4 but makes both the processor 21 and the ESW 22 unable to access the flash memory 23.

The bus switch 24 can be constituted using four switches SWA1 to SWA4, four switches SWB1 to SWB4, two two-input one-output AND operation elements 24a and 24b, one buffer element 24c, and two logic inversion elements 24d and 24e, for example. The switch SWA1 switches connection and interruption between the signal line A1 and the signal line C1, the switch SWA2 switches connection and interruption between the signal line A2 and the signal line C2, the switch SWA3 switches connection and interruption between the signal line A3 and the signal line C3, and the switch SWA4 switches connection and interruption between the signal line A4 and the signal line C4. The switches SWA1 to SWA4 are switched ON or OFF according to an output signal from the AND operation element 24a.

Similarly, the switch SWB1 switches connection and interruption between the signal line B1 and the signal line C1, the switch SWB2 switches connection and interruption between the signal line B2 and the signal line C2, the switch SWB3 switches connection and interruption between the signal line B3 and the signal line C3, and the switch SWB4 switches connection and interruption between the signal line B4 and the signal line C4. The switches SWB1 to SWB4 are switched ON or OFF according to an output signal from the AND operation element 24b.

A selection signal S that is output by the processor 21 is input to the buffer element 24c of the bus switch 24. An output signal from the buffer element 24c is input to the logic inversion element 24e and the AND operation element 24b. An output signal from the logic inversion element 24e is input to the AND operation element 24a. Also, an enable signal OEB that is output by the processor 21 is input to the logic inversion element 24d of the bus switch 24. An output signal from the logic inversion element 24d is input to the AND operation elements 24a and 24b.

Accordingly, if the value of the enable signal OEB is “1”, output from the logic inversion element 24d is “0” and “0” is input to one input of each of the AND operation elements 24a and 24b, and therefore output from the AND operation element 24a and output from the AND operation element 24b are both “0”. If output from the AND operation element 24a and output from the AND operation element 24b are “0”, the switches SWA1 to SWA4 and the switches SWB1 to SWB4 are switched OFF, and the signal lines A1 to A4 and the signal lines B1 to B4 are not connected to the signal lines C1 to C4.

If the value of the enable signal OEB is “0”, “1” is input to one input of each of the AND operation elements 24a and 24b, and therefore output signals from the AND operation elements 24a and 24b are determined by the value of the other input. If the value of the selection signal S is “0”, the value of an output signal from the buffer element 24c is also “0”, and accordingly the value “1” of an output signal from the logic inversion element 24e is input to the AND operation element 24a, while the value “0” of the output signal from the buffer element 24c is input to the AND operation element 24b. Therefore, output from the AND operation element 24a is “1” and the switches SWA1 to SWA4 are switched ON, while output from the AND operation element 24b is “0” and the switches SWB1 to SWB4 are switched OFF. In contrast, if the value of the selection signal S is “1”, the value of an output signal from the buffer element 24c is also “1”, and accordingly the value “0” of an output signal from the logic inversion element 24e is input to the AND operation element 24a, while the value “1” of the output signal from the buffer element 24c is input to the AND operation element 24b. Therefore, output from the AND operation element 24a is “0” and the switches SWA1 to SWA4 are switched OFF, while output from the AND operation element 24b is “1” and the switches SWB1 to SWB4 are switched ON.

As described above, there is no situation in which values of output signals from the two AND operation elements 24a and 24b of the bus switch 24 are both “1” and the switches SWA1 to SWA4 and the switches SWB1 to SWB4 are all switched ON, and therefore the signal lines A1 to A4 and the signal lines B1 to B4 are not simultaneously connected to the signal lines C1 to C4.

### Memory Sharing Method

The processor 21 of the gateway 2 according to the present embodiment controls switching of selection of communication lines by the bus switch 24 in response to switching of the IG signal or the ACC signal of the vehicle 1 between ON and OFF. Although the following describes an example in which the processor 21 controls the bus switch 24 in accordance with the IG signal, the processor 21 may also control the bus switch 24 in accordance with the ACC signal. In response to which of the signals the processor 21 controls the bus switch depends on which of the signals the ESW 22 is activated in response to. In this example, the ESW 22 is activated if the IG signal is switched ON, and enters a waiting state, such as sleep or standby, if the IG signal is switched OFF. Further, a configuration is also possible in which the processor 21 controls switching by the bus switch 24 depending on conditions other than the IG signal and the ACC signal.

If the IG signal is OFF, the processor 21 maintains a state in which the flash memory 23 cannot be accessed, by keeping the enable signal OEB at “1”, for example. If the IG signal is switched from OFF to ON, the processor 21 switches the enable signal OEB to “0” and switches the selection signal S to “1” to connect the signal lines B1 to B4 of the ESW 22 to the signal lines C1 to C4 of the flash memory 23. As a result, the ESW 22 is enabled to access the flash memory 23.

As a result of the IG signal being switched from OFF to ON, the ESW 22 is activated and starts to read the communication program stored in the flash memory 23. First, the ESW 22 reads the value of the reading flag stored in the flash memory 23 by giving a readout command to the flash memory 23. Then, the ESW 22 reads the communication program from the first communication program storage region or the second communication program storage region, which is designated by the read reading flag. It should be noted that the communication program read by the ESW 22 is stored in a memory that is included in the ESW 22, and the CPU or the like of the ESW 22 executes the communication program stored in the memory.

Thereafter, when the ESW 22 has finished reading the communication program from the flash memory 23, the ESW 22 notifies the processor 21 of the completion of reading. Upon receiving the notification from the ESW 22, the processor 21 switches the selection signal S from “1” to “0” to switch the selection of signal lines by the bus switch 24. As a result, the signal lines A1 to A4 of the processor 21 are connected to the signal lines C1 to C4 of the flash memory 23 and the processor 21 is enabled to access the flash memory 23. The processor 21 temporarily stores an update program acquired from the server device 5, by using the update program storage region of the flash memory 23, and performs processing for updating a program of an ECU 3.

Thereafter, if the IG signal is switched from ON to OFF, the processor 21 changes the enable signal OEB to “1” to switch the bus switch 24 to a state in which the flash memory 23 cannot be accessed. However, in a case where the processing for updating a program of an ECU 3 is performed after the IG signal is switched OFF, the processor 21 keeps the enable signal OEB at “0” even after the IG signal is switched OFF, reads the update program stored in the update program storage region of the flash memory 23, and changes the enable signal OEB to “1” after the update processing is finished.

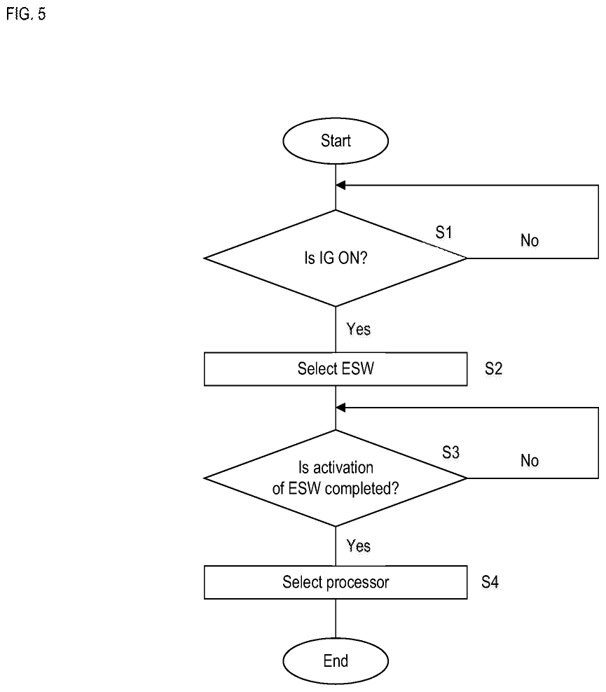

FIG. 5 is a flowchart showing a procedure of processing that is performed by the processor 21 of the gateway 2 to control switching by the bus switch 24. The processor 21 of the gateway 2 according to the present embodiment determines whether or not the IG switch of the vehicle 1 is switched from OFF to ON (step S1). If the IG switch is not switched ON (S1: NO), the processor 21 waits until the IG switch is switched ON. If the IG switch is switched ON (S1: YES), the processor 21 switches the enable signal OEB to “0” and switches the selection signal S to “1” to switch the selection by the bus switch 24 so that the ESW 22 is selected as the element that accesses the flash memory 23 (step S2).

Next, the processor 21 determines whether or not the ESW 22 has finished reading the communication program from the flash memory 23 and activation of the ESW 22 is completed, based on the presence or absence of notification from the ESW 22 (step S3). If activation of the ESW 22 is not completed (S3: NO), the processor 21 waits until activation of the ESW 22 is completed. If activation of the ESW 22 is completed (S3: YES), the processor 21 switches the selection signal S to “0” to switch the selection by the bus switch 24 so that the processor 21 is selected as the element that accesses the flash memory 23 (step S4), and ends processing.

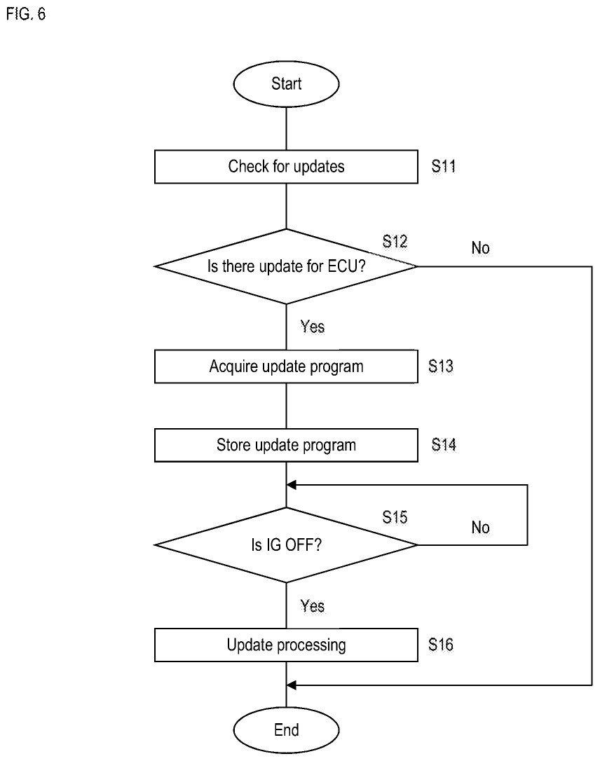

FIG. 6 is a flowchart showing a procedure of processing that is performed by the processor 21 of the gateway 2 to update an ECU 3. At a predetermined timing such as when the ignition switch of the vehicle 1 is switched from OFF to ON, for example, the processor 21 of the gateway 2 according to the present embodiment inquires of the server device 5 whether there are updates for programs of the ECUs 3 installed in the vehicle 1, through wireless communication performed by the wireless communication device 4 (step S11). The processor 21 determines the presence or absence of updates for programs of the ECUs 3 based on a reply from the serer device 5 (step S12). If there is no update for programs of the ECUs 3 (S12: NO), the processor 21 ends processing.

If there is an update for a program of an ECU 3 (S12: YES), the processor 21 acquires an update program for the ECU 3 from the server device 5 through wireless communication performed by the wireless communication device 4 (step S13). The processor 21 stores the update program acquired from the server device 5 in the update program storage region of the flash memory 23 (step S14). Thereafter, the processor 21 determines whether or not the IG switch of the vehicle 1 is switched OFF (step S15). If the IG switch is not switched OFF (S15: NO), the processor 21 waits until the IG switch is switched OFF. If the IG switch is switched OFF (S15: YES), the processor 21 reads the update program stored in the flash memory 23, performs update processing by transmitting the read update program to the ECU 3 to be updated (step S16), and ends processing.

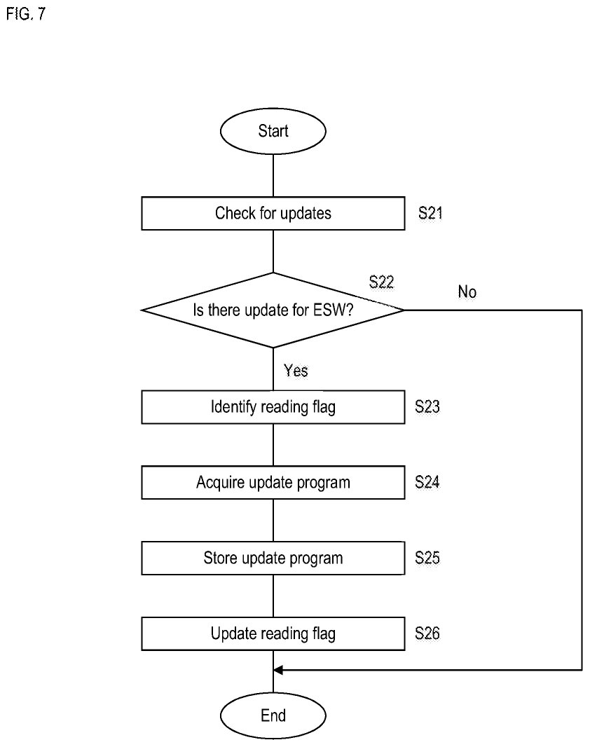

FIG. 7 is a flowchart showing a procedure of processing that is performed by the processor 21 of the gateway 2 to update the ESW 22. At a predetermined timing such as when the ignition switch of the vehicle 1 is switched from OFF to ON, for example, the processor 21 of the gateway 2 according to the present embodiment inquires of the server device 5 whether there is an update for the communication program of the ESW 22, through wireless communication performed by the wireless communication device 4 (step S21). The processor 21 determines the presence or absence of an update for the communication program of the ESW 22 based on a reply from the server device 5 (step S22). If there is no update for the communication program of the ESW 22 (S22: NO), the processor 21 ends processing.

If there is an update for the communication program of the ESW 22 (S22: YES), the processor 21 identifies the value of the reading flag by reading the value of the reading flag stored in the flash memory 23 (step S23). Also, the processor 21 acquires an update program for the ESW 22 from the server device 5 through wireless communication performed by the wireless communication device 4 (step S24). The processor 21 stores the update program acquired at step S24 in a storage region other than the storage region that is designated by the reading flag, based on a result of the identification performed at step S23 (step S25). After storing the update program, the processor 21 updates the value of the reading flag stored in the flash memory 23 to a value that designates the storage region in which the update program is stored (step S26), and ends processing.

### SUMMARY

In the communication system according to the present embodiment configured as described above, the gateway 2 acquires an update program for an ECU 3 from the server device 5 and transmits the acquired update program to the ECU 3 to be updated, and thus a program of the ECU 3 is updated. The gateway 2 includes the processor 21 that performs various kinds of processing including processing for updating ECUs 3 and the ESW 22 that performs processing relating to communication that is performed via communication lines installed in the vehicle 1. The ESW 22 performs various kinds of processing relating to communication by reading and executing a communication program that is stored in the flash memory 23.

In this configuration, the gateway 2 according to the present embodiment includes the flash memory 23 as a shared memory that is accessible by both the processor 21 and the ESW 22. An update program that is acquired from the server device 5 by the processor 21 for the update processing and the communication program executed by the ESW 22 are stored in the flash memory 23. This eliminates the need for providing, as separate elements, a memory element in which the processor 21 stores the update program and a memory element for storing the communication program to be executed by the ESW 22, and therefore the number of memory elements included in the gateway 2 can be reduced.

Further, the gateway 2 includes the bus switch 24 that selectively enables access via an access route from the processor 21 to the flash memory 23 (the signal lines A1 to A4 and the signal lines C1 to C4) or an access route from the ESW 22 to the flash memory 23 (the signal lines B1 to B4 and the signal lines C1 to C4), and the processor 21 controls the selection by the bus switch 24.

If the IG switch of the vehicle 1 is switched from OFF to ON, the processor 21 controls the selection by the bus switch 24 to enable access via the access route from the ESW 22 to the flash memory 23. As a result, when the IG switch is switched from OFF to ON and the gateway 2 starts operation, the ESW 22 can read the communication program from the flash memory 23 and start processing relating to communication. Further, after the communication program is read by the ESW 22 from the flash memory 23, the processor 21 switches the selection by the bus switch 24 to enable access via the access route from the processor 21 to the flash memory 23. As a result, when the processor 21 acquires an update program from the server device 5, the processor 21 can store the update program in the flash memory 23.

It is sufficient that the ESW 22 reads the communication program once, after the device is activated. Therefore, a configuration is possible in which the ESW 22 accesses the flash memory 23 right after the device is activated and thereafter the processor 21 accesses the flash memory 23, and thus the flash memory 23 can be shared without access from the processor 21 to the flash memory 23 and access from the ESW 22 to the flash memory 23 colliding with each other.

Further, the gateway 2 is capable of updating the communication program executed by the ESW 22. The flash memory 23 includes the first and second communication program storage regions in which the communication program can be stored, and the reading flag that indicates from which of the storage regions the ESW 22 is to read the communication program is stored in the flash memory 23. The ESW 22 reads the communication program from the storage region that is indicated by the reading flag and executes the communication program. Therefore, an update program for the ESW 22 can be stored in the storage region that is not indicated by the reading flag, without operation of the ESW 22 being affected.

After the processor 21 has stored the update program for the ESW 22 acquired from the server device 5 in the storage region that is not indicated by the reading flag, the processor 21 updates the reading flag so that the ESW 22 will read the communication program from this storage region. As a result, the next time the ESW 22 reads the communication program, the update program acquired by the processor 21 and stored in the flash memory 23 is read as the communication program, and thus the communication program can be updated.

Although the flash memory 23 is shared by the processor 21 and the ESW 22 in the present embodiment, this is not a limitation, and a memory element such as an EEPROM may be shared, for example. Further, although an example is described in which the processor 21 and the ESW 22 are the ICs that share a memory, this is not a limitation, and a configuration is also possible in which various ICs other than the processor and the ESW share a memory. Further, the circuit configuration of the bus switch 24 shown in FIG. 4 is an example and is not a limitation.

1. An in-vehicle relay device to which a plurality of communication lines installed in a vehicle are connectable and that performs processing for relaying communication between the plurality of communication lines, the in-vehicle relay device comprising:
a processor that includes an acquisition unit configured to acquire an update program for updating a program that is executed by an in-vehicle device connected to one of the communication lines and an update processing unit configured to perform processing for updating a program by transmitting an update program acquired by the acquisition unit to the in-vehicle device;
a communication Integrated Circuit (IC) configured to perform, by executing a communication program, processing relating to communication that is performed via the plurality of communication lines; and
a shared memory that is accessible by the processor and the communication IC,
wherein an update program acquired by the acquisition unit of the processor and the communication program executed by the communication IC are stored in the shared memory.

2. The in-vehicle relay device according to claim 1, further comprising
a route selection unit configured to selectively enable access via an access route from the processor to the shared memory or an access route from the communication IC to the shared memory,
wherein the processor controls selection of a route by the route selection unit.

3. The in-vehicle relay device according to claim 2,
wherein, if an ignition switch or an accessory switch of the vehicle is switched from OFF to ON, the processor controls selection of a route by the route selection unit to enable access via the access route from the communication IC to the shared memory, and
after the communication program stored in the shared memory is read by the communication IC, the processor controls selection of a route by the route selection unit to enable access via the access route from the processor to the shared memory.

4. The in-vehicle relay device according to claim 1,
wherein the shared memory includes a plurality of storage regions for storing the communication program, and region information that indicates from which of the storage regions the communication IC is to read the communication program is stored in the shared memory, and
the communication IC reads the communication program from a storage region of the shared memory that is indicated by the region information.

5. The in-vehicle relay device according to claim 4,
wherein the processor acquires an update program for the communication IC through the acquisition unit, stores the update program in one of the storage regions of the shared memory, and updates the region information.

6. A control program that causes a processor included in an in-vehicle relay device that performs processing for relaying communication between a plurality of communication lines installed in a vehicle to:
acquire an update program for updating a program that is executed by an in-vehicle device connected to one of the communication lines;
perform processing for storing the acquired update program in a shared memory that is accessible by a communication IC that performs, by executing a communication program, processing relating to communication that is performed via the plurality of communication lines;
perform processing for updating a program by transmitting the update program stored in the shared memory to the in-vehicle device; and
control selection of a route by a route selection unit that selectively enables access via an access route from the processor to the shared memory or an access route from the communication IC to the shared memory.

7. The control program according to claim 6,
wherein, if an ignition switch or an accessory switch of the vehicle is switched from OFF to ON, the control program causes the processor to control selection of a route by the route selection unit to enable access via the access route from the communication IC to the shared memory, and
after the communication program that is stored in the shared memory is read by the communication IC, the control program causes the processor to control selection of a route by the route selection unit to enable access via the access route from the processor to the shared memory.

8. A memory sharing method for sharing a memory between a processor and a communication IC that are included in an in-vehicle relay device that performs processing for relaying communication between a plurality of communication lines that are installed in a vehicle, the method comprising:
acquiring, by the processor, an update program for updating a program that is executed by an in-vehicle device connected to one of the communication lines, storing, by the processor, the acquired update program in a shared memory, and performing, by the processor, processing for updating a program by transmitting the stored update program to the in-vehicle device; and
performing, by the communication IC, processing relating to communication that is performed via the plurality of communication lines, by executing a communication program that is stored in the shared memory.

9. The in-vehicle relay device according to claim 2,
wherein the shared memory includes a plurality of storage regions for storing the communication program, and region information that indicates from which of the storage regions the communication IC is to read the communication program is stored in the shared memory, and
the communication IC reads the communication program from a storage region of the shared memory that is indicated by the region information.

10. The in-vehicle relay device according to claim 3,
wherein the shared memory includes a plurality of storage regions for storing the communication program, and region information that indicates from which of the storage regions the communication IC is to read the communication program is stored in the shared memory, and
the communication IC reads the communication program from a storage region of the shared memory that is indicated by the region information.
